(19) United States
(12) Patent Application Publication
(10) Pub. No.: US 2014/0288873 A1
(43) Pub. Date: Sep. 25, 2014

(54) PRE-PROCESSING INERTIAL SENSOR MEASUREMENTS FOR NAVIGATION

(71) Applicant: QUALCOMM Incorporated, San Diego, CA (US)

(72) Inventors: Joseph Czompo, San Jose, CA (US); Manish Kushwaha, San Jose, CA (US)

(73) Assignee: QUALCOMM Incorporated, San Diego, CA (US)

(21) Appl. No.: 14/147,274

(22) Filed: Jan. 3, 2014

Related U.S. Application Data
(60) Provisional application No. 61/804,521, filed on Mar. 22, 2013.

(51) Int. Cl. G01C 19/00

(52) U.S. Cl. CPC G01C 19/00
USPC 702/141

(57) ABSTRACT

Example methods, apparatuses, or articles of manufacture are disclosed herein that may be utilized, in whole or in part, to facilitate or support one or more operations or techniques for pre-processing inertial sensor measurements for navigation for use in or with a mobile communication device.

### CROSS-REFERENCE TO RELATED APPLICATIONS

The present application claims the benefit of and priority to U.S. Provisional Patent Application Ser. No. 61/804,521, entitled “Methods and Apparatuses for Preprocessing Inertial Sensor Measurements for Navigation,” filed on Mar. 22, 2013, which is assigned to the assignee hereof and which is expressly incorporated herein by reference.

### BACKGROUND

1. Field

The present disclosure relates generally to motion sensing in mobile communication devices and, more particularly, to pre-processing inertial sensor measurements for navigation for use in or with mobile communication devices.

2. Information

Mobile communication devices, such as, for example, cellular telephones, portable navigation units, laptop computers, personal digital assistants, or the like are becoming more common every day. These devices may include, for example, a variety of sensors to support a number of applications in today's market. A popular market trend in sensor-enabled mobile technology includes, for example, applications that may sense or recognize one or more aspects of a motion of a mobile communication device and use such aspects as a form of input. For example, certain applications may sense or recognize one or more informative hand or wrist gestures of a user and may use such gestures as inputs representing user commands or selections in various motion-enabled games, web page browsing, indoor or outdoor navigation, or the like.

At times, motion-enabled applications may utilize one or more motion sensors capable of converting physical phenomena into analog or digital signals. These sensors may be integrated into (e.g., built-in, etc.) or otherwise supported by (e.g., stand-alone, etc.) a mobile communication device and may detect a motion of the device by measuring, for example, the direction of gravity or magnetic field, luminous intensity of the ambient light, various vibrations, or the like. For example, a mobile communication device may feature one or more accelerometers, gyroscopes, magnetometers, gravitometers, ambient light detectors, proximity sensors, thermometers, etc., capable of measuring various motion states, orientations, locations, etc. of the mobile device. These sensors may be utilized individually or in combination with other sensors, depending on a particular application. The utilization of multiple sensors, however, may present a number of challenges, such as increased complexity, size, cost, etc. of a mobile communication device.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is an implementation of an example coordinate system that may be applied to a mobile device.

FIG. 2 is a flow diagram illustrating an implementation of an example process for pre-processing inertial sensor measurements for navigation.

FIG. 3 is an implementation of an example plot illustrating acceleration and gyroscope samples as a function of time.

FIGS. 4 through 7 are implementations of example plots illustrating integration schemes.

FIG. 8 is a flow diagram illustrating another implementation of an example process for pre-processing inertial sensor measurements for navigation.

FIG. 9 is a schematic diagram illustrating an implementation of an example computing environment associated with a mobile device.

FIG. 10 is a schematic diagram illustrating an implementation of an example computing environment associated with a server.

### SUMMARY

Example implementations relate to pre-processing inertial sensor measurements for navigation for use in or with a mobile communication device. In one implementation, a method may comprise receiving, at a mobile device, a first series of measurement samples from an accelerometer obtained in a first series of spatial orientations in a measurement reference frame; receiving a second series of measurement samples from a gyroscope obtained in a second series of spatial orientations in the measurement reference frame, the first series of measurement samples being temporally misaligned with the second series of measurement samples; interpolating the received second series of measurement samples obtained in the second series of spatial orientations to sampling times of the received first series of measurement samples obtained in the first series of spatial orientations; generating a third series of measurement samples based, at least in part, on the received second series of measurement samples and the interpolated second series of measurement samples; integrating the third series of measurement samples to obtain amounts of rotation corresponding to the sampling times of the received first series of measurement samples; and transforming the first series of measurement samples to the first series of spatial orientations in the measurement reference frame based, at least in part, on the amounts of rotation.

In another implementation, an apparatus may comprise a mobile device comprising an accelerometer; a gyroscope; and one or more processors programmed with instructions to receive a first series of measurement samples from the accelerometer obtained in a first series of spatial orientations in a measurement reference frame; receive a second series of measurement samples from the gyroscope obtained in a second series of spatial orientations in the measurement reference frame, the first series of measurement samples being temporally misaligned with the second series of measurement samples; interpolate the received second series of measurement samples obtained in the second series of spatial orientations to sampling times of the received first series of measurement samples obtained in the first series of spatial orientations; generate a third series of measurement samples based, at least in part, on the received second series of measurement samples and the interpolated second series of measurement samples; integrate the third series of measurement samples to obtain amounts of rotation corresponding to the sampling times of the received first series of measurement samples; and transform the first series of measurement samples to the first series of spatial orientations in the measurement reference frame based, at least in part, on the amounts of rotation.

In yet another implementation, an apparatus may comprise means for receiving, at a mobile device, a first series of measurement samples from an accelerometer obtained in a first series of spatial orientations in a measurement reference frame; means for receiving a second series of the measurement reference frame, the first series of measurement samples being temporally misaligned with the second series of measurement samples; means for interpolating the received second series of measurement samples obtained in the second series of spatial orientations to sampling times of the received first series of measurement samples obtained in the first series of spatial orientations; means for generating a third series of measurement samples based, at least in part, on the received second series of measurement samples and the interpolated second series of measurement samples; means for integrating the third series of measurement samples to obtain amounts of rotation corresponding to the sampling times of the received first series of measurement samples; and means for transforming the first series of measurement samples to the first series of spatial orientations in the measurement reference frame based, at least in part, on the amounts of rotation.

In yet another implementation, an article may comprise a non-transitory storage medium having instructions stored thereon executable by a special purpose computing platform to receive, at a mobile device, a first series of measurement samples from an accelerometer obtained in a first series of spatial orientations in a measurement reference frame; receive a second series of measurement samples from a gyroscope obtained in a second series of spatial orientations in the measurement reference frame, the first series of measurement samples being temporally misaligned with the second series of measurement samples; interpolate the received second series of measurement samples obtained in the second series of spatial orientations to sampling times of the received first series of measurement samples obtained in the first series of spatial orientations; generate a third series of measurement samples based, at least in part, on the received second series of measurement samples and the interpolated second series of measurement samples; integrate the third series of measurement samples to obtain amounts of rotation corresponding to the sampling times of the received first series of measurement samples; and transform the first series of measurement samples to the first series of spatial orientations in the measurement reference frame based, at least in part, on the amounts of rotation. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate or support one or more operations or techniques for pre-processing inertial sensor measurements for navigation for use in or with a mobile communication device. As used herein, “mobile communication device,” “wireless device,” “location-aware mobile device,” or the plural form of such terms may be used interchangeably and may refer to any kind of special purpose computing platform or apparatus that may from time to time have a position or location that changes. As a way of illustration, changes in position or location may comprise, for example, changes to direction, distance, orientation, or the like, as a few examples. In some instances, a mobile communication device may, for example, be capable of communicating with one or more other devices, mobile or otherwise, through wireless transmission or receipt of information over suitable communications networks according to one or more communication protocols. As a way of illustration, special purpose mobile communication devices, which may herein be called simply mobile devices, may include, for example, cellular telephones, satellite telephones, smart telephones, personal digital assistants (PDAs), laptop computers, personal entertainment systems, tablet personal computers (PC), personal audio or video devices, personal navigation devices, or the like. It should be appreciated, however, that these are merely illustrative examples of mobile devices that may be utilized, in whole or in part, in connection with one or more operations or techniques discussed herein, and that claimed subject matter is not limited in this regard.

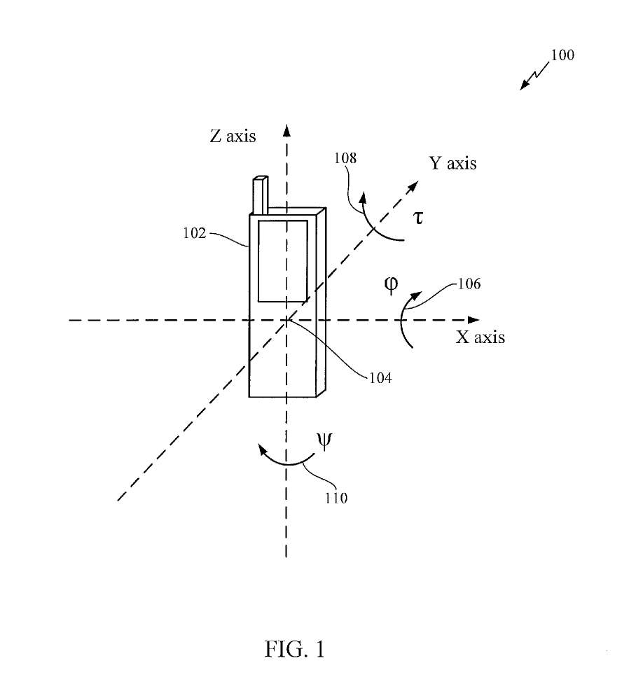

As alluded to previously, a mobile device may include a number of inertial or motion sensors, such as, for example, one or more accelerometers, gyroscopes, gravitometers, tilt sensors, or the like. These sensors may be capable of providing signals representative of sensor measurements with respect to acceleration, rotation, tilt, local gravitational field, etc. for use by a variety of host applications while detecting various motions of a mobile device. As used herein, a “motion” may refer to a physical displacement of an object, such as a mobile device, for example, relative to some frame of reference. For example, a physical displacement may include changes in terms of an object's velocity, position, orientation, or the like. An accelerometer may, for example, sense a direction of gravity toward the center of the Earth and may detect or measure a motion with reference to one, two, or three directions often referenced in a Cartesian coordinate space as dimensions or axes X, Y, and Z. In some instances, an accelerometer may also provide measurements of magnitude of various accelerations. A gyroscope may, for example, utilize the Coriolis effect and may provide angular rate measurements or rotations in roll, pitch, or yaw dimensions. A gyroscope may be used, at least in part, in applications determining heading or azimuth changes, for example. A direction of gravity or rotation may be measured in relation to any suitable frame of reference, such as, for example, in a coordinate system in which the origin or initial point of gravity vectors is fixed to or moves with a mobile device. An example coordinate system that may be used, in whole or in part, to facilitate or support one or more operations or techniques discussed herein will be described in greater detail below in connection with FIG. 1.

As was indicated, inertial sensor measurements may be used, at least in part, by motion-enabled applications, such as games interpreting user's hand or wrist gestures as inputs representative of various selections or commands, for example. Inertial sensor measurements may also be used, at least in part, by a location or navigation application interpreting user's gestures as instructions, for example, to determine an orientation of a mobile device relative to some reference within a physical environment, to estimate a location of a mobile device or navigation target, to suggest or confirm a navigation route, or the like. In addition, signals from inertial sensors may be provided to facilitate or support various functionalities in connection with selecting or browsing through information on a mobile device. For example, via gestures, a user may select, fast forward, or rewind music, zoom, pan, or browse through digital maps or Web content, select suitable or desired navigation options from on-screen menus, or the like. Of course, details relating to motion-enabled applications or functionalities of a mobile device are merely examples, and claimed subject matter is not so limited.

In some instances, it may be advantageous or useful to integrate inertial sensor measurements from multiple sensors so as to enhance user's experience, satisfy positioning or other application requirements, or the like. For example, in navigation applications, it may be useful to integrate sensor measurements from both an accelerometer and a gyroscope to provide or obtain adequate or otherwise suitable degrees of observability. At times, however, the utilization of measurements from multiple sensors may present a number of challenges. As a way of illustration, a signal measurement acquisition system for integrating measurements from multiple sensors may, for example, be subject to various timing errors. Namely, different sensors may, for example, be sampled for measurement data at different times (e.g., sampling is not synchronized between or among sensors, etc.), at different sample rates (e.g., samples from different sensors are provided at a different rate, etc.), or at irregular times (e.g., a sampling rate is highly variable, etc.). As such, measurement samples from multiple sensors may be temporally misaligned (e.g., have non-matching time stamps, etc.), for example, thus, covering a possibly different time interval with varying delays that may be different for a type of a sensor. In some instances, such as if signal processing assumes simultaneous sampling, for example, lack of sample synchronization or misalignment may not be taken into account. This may lead to errors or undesirable results, for example, thus, making positioning or navigation capabilities of certain mobile devices less useful or possibly faulty. Accordingly, it may be desirable to develop one or more methods, systems, or apparatuses that may implement more effective or efficient sensor data integration, such as with respect to inertial sensor measurements obtained from an accelerometer and gyroscope, for example.

Thus, as will be described in greater detail below, in an implementation, temporally misaligned or irregularly sampled acceleration and gyroscope measurements may be pre-processed in some manner, such as in a computed coordinate system allowing for proper or otherwise suitable sample integration, for example. Namely, a number of sensor measurement samples, which may herein be called simply measurements or samples, for which acceleration and gyroscope measurements are available at approximately the same time may, for example, be selected. Gyroscope samples, such as represented via measurements obtained via a suitable integration period or interval, for example, may be integrated to acceleration sample times. Based, at least in part, on originally selected as well as integrated gyroscope samples, a rotation angle between two acceleration samples, such as represented via respective boundary time stamps, for example, may be computed. Utilizing a computed rotation angle, acceleration samples may, for example, be rotated to a coordinate system at the beginning of an integration period. Based, at least in part, on rotated acceleration samples, integrated acceleration may, for example, be produced or implemented. For example, pre-processed inertial sensor measurements may be provided to a suitable navigation or positioning application for further processing, such as for determining or utilizing delta velocity, average acceleration (e.g., delta velocity divided by time difference) over a suitable time interval, or the like.

FIG. 1 illustrates an example coordinate system 100 that may be used, in whole or in part, to facilitate or support measurements obtained via inertial sensors of a mobile device, such as a mobile device 102, just to illustrate one possible implementation. As previously mentioned, inertial sensor measurements may be obtained based, at least in part, on output signals generated by an associated accelerometer or gyroscope, for example. As illustrated, example coordinate system 100 may comprise, for example, three-dimensional Cartesian coordinate system, though claimed subject matter is not so limited. In this illustrated example, motion of mobile device 102 representing, for example, acceleration vibration may be detected or measured, at least in part, by a suitable accelerometer, such as a three-dimensional (3D) accelerometer, for example, with reference to three linear dimensions or axes X, Y, and Z relative to the origin 104 of example coordinate system 100. It should be appreciated that example coordinate system 100 may or may not be aligned with a body of mobile device 102. It should also be noted that in certain implementations a non-Cartesian coordinate system may be used or that a coordinate system may define dimensions that are mutually orthogonal.

At times, rotational motion of mobile device 102, such as orientation changes about gravity, for example, may be detected or measured, at least in part, by a suitable accelerometer with reference to one or two dimensions. For example, in some instances, rotational motion of mobile device 102 may be detected or measured in terms of coordinates (φ, τ), where phi (φ) represents roll or rotation about an X axis, as illustrated generally by arrow at 106, and tau (τ) represents pitch or rotation about an Y axis, as illustrated generally at 108. As discussed below, rotational motion of mobile device 102 may also be detected or measured by a suitable gyroscope, such as, for example, with respect to X, Y, and Z orthogonal axes. Accordingly, a 3D accelerometer may detect or measure, at least in part, a level of acceleration vibration as well as a change about gravity with respect to roll or pitch dimensions, for example, thus, providing five dimensions of observability (X, Y, Z, φ, τ). Of course, these are merely examples of motions that may be detected or measured, at least in part, with reference to example coordinate system 100, and claimed subject matter is not limited to particular motions or coordinate system.

As was indicated, in some instances, rotational motion of mobile device 102 may, for example, be detected or measured, at least in part, by a suitable gyroscope so as to provide adequate or suitable degrees of observability. For example, a gyroscope may detect or measure rotational motion of mobile device 102 with reference to one, two, or three dimensions. Thus, in some instances, gyroscopic rotation may, for example, be detected or measured, at least in part, in terms of coordinates (φ, τ, ψ), where phi (φ) represents roll or rotation 106 about an X axis, tau (τ) represents pitch or rotation 108 about an Y axis, and psi (ψ) represents yaw or rotation about a Z axis, as referenced generally at 110. A gyroscope may typically, although not necessarily, provide measurements in terms of angular acceleration (e.g., a change in an angle per unit of time squared), angular velocity (e.g., a change in an angle per unit of time), or the like. Likewise, here, details relating to motions that may be detected or measured, at least in part, by a gyroscope with reference to example coordinate system 100 are merely examples, and claimed subject matter is not so limited.

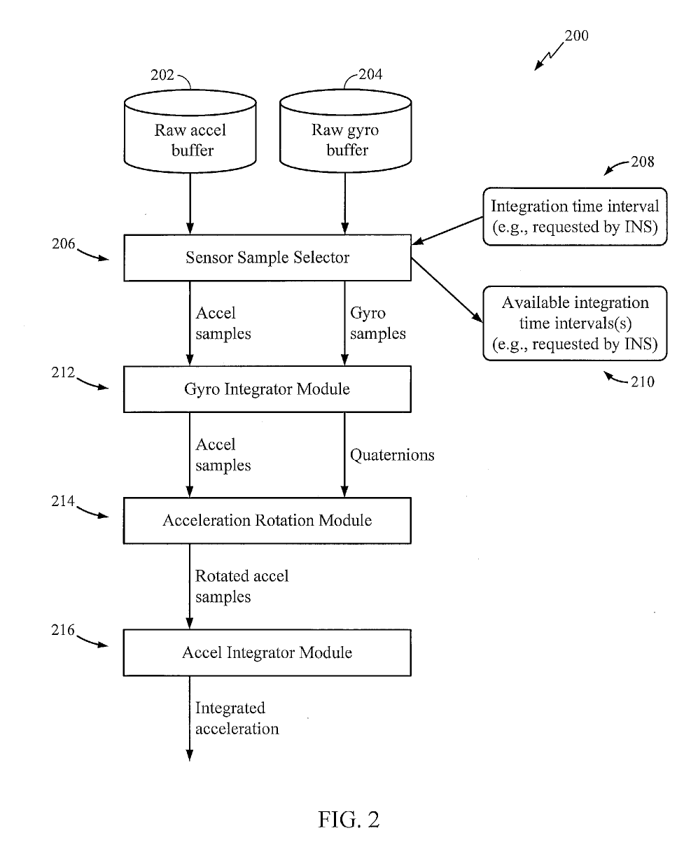

With this in mind, attention is now drawn to FIG. 2, which is a flow diagram illustrating a summary of an implementation of an example process 200 that may be performed, in whole or in part, to facilitate or support one or more operations or techniques for pre-processing inertial sensor measurements for navigation for use in or with a mobile device, such as mobile device 102 of FIG. 1, for example. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

As alluded to previously, in some instances, measurements from an accelerometer and gyroscope may arrive (e.g., at a processor for pre-processing, etc.) in separate messages or like packets (e.g., transmitted via a bus, etc.) and, as such, may be temporally misaligned. For example, messages may have non-matching time stamps, may cover a possibly different time interval, may have varying delays that may be different for a type of a sensor, or the like. At times, measurements from an accelerometer and gyroscope may be collected or gathered in one or more suitable data repositories, such as, for example, a raw accelerometer buffer and a raw gyroscope buffer, illustrated respectively at 202 and 204, just to illustrate one possible implementation. It should be noted that buffers 202 and 204 may be relatively large so as to facilitate or support one or more operations or techniques discussed herein. By way of example but not limitation, in one particular simulation or experiment, buffers 202 and 204 were capable of storing 2.0 or more seconds of respective measurements for a type of sensor, though claimed subject matter is not so limited.

At operation 206, a Sensor Sample Selector may, for example, implement a sensor time alignment functionality of process 200 by identifying or selecting a group of samples for which acceleration and gyroscope samples are available at approximately the same time (e.g., capable of being processed together, etc.). A Sensor Sample Selector may, for example, facilitate or support proper or otherwise suitable sample integration between specified or appropriate integration times. In some instances, a Sensor Sample Selector may also determine which integration times are available, such as for use by a suitable Inertial Navigation System (INS) or module. It should be noted that the terms “system” and “module” may be used interchangeably herein. For example, at illustrated via an arrow at 208, in at least one implementation, an INS may request a particular integration time interval, and may be offered or provided with one or more available integration time intervals based, at least in part, on availability of sensor samples, as indicated at 210. It should be noted that, in some instances, an INS may, for example, determine or request a time interval for integration based, at least in part, on one or more available integration time intervals offered or provided by a Sensor Sample Selector. As also illustrated, a Sensor Sample Selector may provide or otherwise make available selected acceleration and gyroscope samples to a suitable sample integration system, such as a Gyroscope Integrator Module, for example, discussed below.

By way of example but not limitation, in one particular simulation or experiment, it has been observed that, for sample selection, an exact time match may not be required or useful, but certain conditions may enable more effective or efficient integration of measurements from an accelerometer and gyroscope. For example, in some instances, the following may apply:

There may be at least one acceleration sample whose time stamp tₖ is not greater than an integration start time tₛₜₐᵣₜ.

There may be at least one acceleration sample whose time stamp tₖ₊ₙ is not smaller than an integration end time t_{end.}

There may be at least one gyroscope sample whose time stamp is not greater than that of a first acceleration sample tₖ.

There may be at least one gyroscope sample whose time stamp is not smaller than that of a last acceleration sample tₖ₊ₙ.

At times, a number of non-equidistant, irregular sample time stamps may, for example, be selected and utilized, at least in part, such as in connection with one or more operations discussed below. Also, in some instances, example process 200 may be capable of utilizing occasionally missing samples, such as in a quasi-regular sensor data stream, for example. Measurement samples may, for example, be lost or may be further apart than expected at a given sampling rate, which may be due, at least in part, to timing issues in a multi-sensor signal measurement acquisition system. Thus, in some instances, a sensor data outage may, for example, be declared if a time difference between two neighboring samples is relatively large, such that if an interpolation between these samples may not be carried out reliably or meaningfully, for example. This may be expressed as:

tₖ₊₁−tₖ>T_{outage,max}

where T_{outage,max} is the maximum tolerable time difference between samples.

By way of example but not limitation, in some instances, it may be expected that data gaps up to, for example, T_{outage,max}=150 ms may be bridged, though claimed subject matter is not so limited. It should be noted that data gaps may be determined, at least in part, experimentally and may be pre-defined or configured, for example, or otherwise dynamically defined in some manner, depending on a particular application, environment, sensor frame, or the like.

With regard to operation 212, a Gyroscope Integrator Module may enable gyroscope samples to be properly integrated throughout a suitable integration interval, such as up to each and every acceleration sample time, for example. Here, three dimensional rotations between coordinate systems corresponding to acceleration samples may, for example, be determined by integrating rotation rates measured by gyroscopes. As previously mentioned, at times, acceleration and gyroscope sample measurements as well as integration times may not be temporally aligned or synchronized, so pre-processing of inertial sensor measurements may not be straightforward. Thus, a Gyro Integrator Module may, for example, integrate gyroscope measurements to present coordinate system rotations with respect to a computed coordinate system at tₛₜₐᵣₜ. Rotated coordinate systems may be taken at acceleration sampling times, for example, and may be represented via any suitable amounts of rotation. For example, in at least one implementation, quaternions may be employed, just to illustrate one possible implementation. Here, quaternions q may, for example, represent rotations from a coordinate system at tₖ to a coordinate system at t_start denoted as q_{t_start,t_k}.

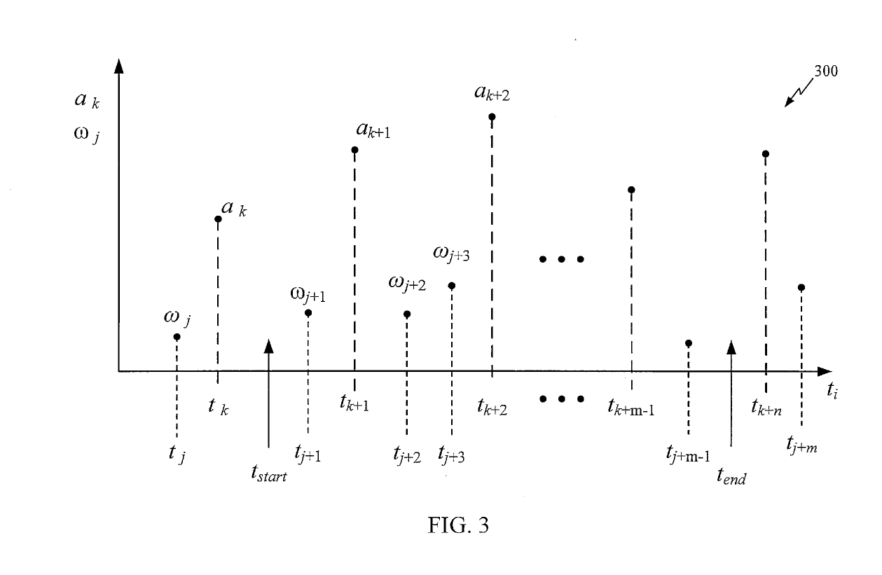

Referring now to FIG. 3, which is an implementation of an example plot 300 illustrating acceleration and gyroscope samples as a function of time, along with integration start and end times. In some instances, gyroscope integration may, for example, be implemented or performed via two steps. For example, initially, gyroscope rates may be interpolated to acceleration sampling times as well as to integration start and end times. Here, any suitable interpolation methods or approaches may be utilized, in whole or in part. As a way of illustration, in at least one implementation, a linear-type interpolation may be employed. More specifically, for an acceleration time stamp, gyroscope samples, denoted via ω, “surrounding” the acceleration time stamp may, for example, be selected for interpolation as:

$${t}_{j} < {t}_{k} < {t}_{j + 1}$$

$$ω ( {t}_{k} ) = {ω}_{j} + ( {ω}_{j + 1} - {ω}_{j} ) \cdot \frac{( {t}_{k} - {t}_{j} )}{( {t}_{j + 1} - {t}_{j} )}$$

Likewise, for start and end time stamps, those gyroscope samples may, for example, be selected for interpolation whose time stamps may “surround” these:

$${t}_{j} < {t}_{start} < {t}_{j + 1}$$

$$ω ( {t}_{start} ) = {ω}_{j} + ( {ω}_{j + 1} - {ω}_{j} ) \cdot \frac{( {t}_{start} - {t}_{j} )}{( {t}_{j + 1} - {t}_{j} )}$$

$${t}_{j + m - 1} < {t}_{end} < {t}_{j + m}$$

$$ω ( {t}_{end} ) = {ω}_{j + m - 1} + ( {ω}_{j + m} - {ω}_{j} ) \cdot \frac{( {t}_{end} - {t}_{j + m - 1} )}{( {t}_{j + m} - {t}_{j + m - 1} )}$$

In a second step, appropriate amounts of rotation between coordinate systems at acceleration sampling times and an integration start time, such as represented via quaternions, for example, may be computed. For example, amounts of rotation may be computed successively, such as using a previous quaternion that was computed up to a previous acceleration sample. Thus, consider:

q̅tₛₜₐᵣₜ,tₖ₊ᵢ= q̅tₛₜₐᵣₜ,tₖ₊ᵢ₋₁· q̅tₖ₊ᵢ₋₁,tₖ₊ᵢ

At times, a quaternion between acceleration samples, or between a first acceleration sample after a start time and the start time itself, for example, may comprise elementary quaternions that may involve gyroscope samples in between as follows:

q̅tₖ₊ᵢ₋₁,tₖ₊ᵢ= q̅tₖ₊ᵢ₋₁,tⱼ₊ₗ· q̅tⱼ₊ₗ₊₁,tⱼ₊ₗ₊₁· . . . · q̅tⱼ₊ₗ₊ᵣ,tₖ₊ᵢ

Or, via samples illustrated in example plot 300 of FIG. 3:

q̅tₖ₊₁,tₖ₊₂= q̅tₖ₊₁,tⱼ₊₁· q̅tⱼ₊₁tⱼ₊₂· q̅ⱼ₊₂,tₖ₊₂

An elementary quaternion q̅tⱼ₊ₗ,tⱼ₊ₗ₊₁ may be attributed to an average rotation rate vector between its two boundary time stamps as, for example:

$$ω ( {t}_{j + l} , {t}_{j + l + 1} ) = \frac{ω ( {t}_{j + l} ) + ω ( {t}_{j + l + 1} )}{2}$$

A corresponding rotation angle may, for example, be computed from an average rotation vector magnitude as:

α(tⱼ₊ₗ,tⱼ₊₁₊₁)=ω(tⱼ₊ₗ,tⱼ₊ₗ₊ₗ)·(tⱼ₊ₗ₊₁−tⱼ₊ₗ)

where

ω(tⱼ₊ₗ,tⱼ₊ₗ₊₁)=∥ω(tⱼ₊ₗ,tⱼ₊ₗ₊₁)∥

A corresponding quaternion may, for example, be computed as:

$${\vec{q}}_{{t}_{j + l} , {t}_{j + l + 1}} = [ \begin{matrix}cos ( \frac{α}{2} ) \\ \frac{{ω}_{x}}{ω} \cdot sin ( \frac{α}{2} ) \\ \frac{{ω}_{y}}{ω} \cdot sin ( \frac{α}{2} ) \\ \frac{{ω}_{z}}{ω} \cdot sin ( \frac{α}{2} )\end{matrix} ]$$

where

α=α(tⱼ₊ₗ,tⱼ₊ₗ₊₁),ω=ω(tⱼ₊ₗ,tⱼ₊ₗ₊₁)

may, for example, be used for brevity with

$$ω ( {t}_{j + l} , {t}_{j + l + 1} ) = [ \begin{matrix}{ω}_{x} \\ {ω}_{y} \\ {ω}_{z}\end{matrix} ]$$

In some instances, such as if ω=0, for example, the above formulation may not be useful or otherwise applicable. Thus, consider, for example, an identity quaternion (e.g., no rotation, etc.):

$${\vec{q}}_{{t}_{j + l} , {t}_{j + l + 1}} = [ \begin{matrix}1 \\ 0 \\ 0 \\ 0\end{matrix} ]$$

As was indicated, rotations corresponding to acceleration sample times may be computed with respect to a start time as, for example:

q̅tₛₜₐᵣₜ,tₖ₊ᵢ= q̅tₛₜₐᵣₜ,tₖ₊₁· q̅tₖ₊₁,tₖ₊₂· . . . · q̅tᵢ₋₁,tᵢ

As will be seen, quaternions may be provided or made available, such as along with suitable acceleration samples, for example, to an Acceleration Rotation Module for rotating acceleration vectors, discussed below.

At times, the above formulation may, for example, be computed via an expression for a product of two quaternions r=p·q as:

$$[ \begin{matrix}{r}_{0} \\ {r}_{1} \\ {r}_{2} \\ {r}_{3}\end{matrix} ] = [ \begin{matrix}{p}_{0} & - {p}_{1} & - {p}_{2} & - {p}_{3} \\ {p}_{1} & {p}_{0} & - {p}_{3} & {p}_{2} \\ {p}_{2} & {p}_{3} & {p}_{0} & - {p}_{1} \\ {p}_{3} & - {p}_{2} & {p}_{1} & {p}_{0}\end{matrix} ] \cdot [ \begin{matrix}{q}_{0} \\ {q}_{1} \\ {q}_{2} \\ {q}_{3}\end{matrix} ]$$

In an implementation, one or more integration approaches discussed herein may, for example, integrate batches of sensor samples as they arrive. Thus, in addition to integrating sensor samples in a current batch, integrated data may, for example, be accumulated across multiple batches of sensor samples. In some instances, a time period for data accumulation may be reset if, for example, sensor bias corrections are received indicating that a new position fix is obtained and new biases are applicable. At times, a data accumulation period may be reset if, for example, it exceeds a certain time threshold. In one particular simulation or experiment a threshold for resetting an accumulation period of 1000.0 msec was used, though claimed subject matter is not so limited. Thus, consider:

I_{B}_{_{1,}}_{B}_{_{K}}=I_{B}_{_{1,}}_{B}_{_{K−1}}+I_{B}_{_{K}}

B_{K}=(t₀^{K},t₁^{K}, . . . ,t_{N}^{K})

where B_{K} is the K^{th} batch of sensor samples that may include N samples time stamped at (thd 0^{K},t₁^{K}, . . . ,t_{N}^{K}). Thus, consider:

$$\begin{matrix}{I}_{{B}_{K}} = {\int }_{{t}_{0}^{K}}^{{t}_{N}^{K}} a [ {t}_{j}^{K} ] d t \\ = {\int }_{{t}_{0}^{K}}^{{t}_{1}^{K}} a [ {t}_{j}^{K} ] d t + {\int }_{{t}_{1}^{K}}^{{t}_{2}^{K}} a [ {t}_{j}^{K} ] d t + … + {\int }_{{t}_{N - 1}^{K}}^{{t}_{N}^{K}} a [ {t}_{j}^{K} ] d t\end{matrix}$$

$${a}^{->} ⌊ {t}_{j}^{K} ⌋ = {q}_{{t}_{0}^{{ }_{{B}_{1}}} {t}_{j}^{K}} \cdot {{a}^{->}}_{k} \cdot {q}_{{t}_{0}^{{B}_{1}} {t}_{j}^{K}}^{*}$$

$${\vec{q}}_{{t}_{0}^{{B}_{1}} {t}_{j}^{K}} = {\vec{q}}_{{t}_{0}^{{B}_{1}} {t}_{0}^{K}} \cdot {\vec{q}}_{{t}_{1}^{K} {t}_{2}^{K}} \cdot … \cdot {\vec{q}}_{{t}_{j - 1}^{K} {t}_{j}^{K}}$$

Here, a quaternion may be defined, for example, via a full quaternion rotation with respect to a first sample in a first batch since an accumulation started.

Referring back to process 200 of FIG. 2, at operation 214, an Acceleration Rotation Module may, for example, rotate acceleration samples to a coordinate system at the beginning of an integration period, such as to map or align these samples in the same coordinate system. As was indicated, since a spatial orientation of a sensor frame associated with a mobile device may change, simple integration of an original acceleration samples may not be correct or useful because, in general, the samples are defined according to different coordinate systems. Accordingly, an Acceleration Rotation Module may, for example, compute a set of rotated acceleration samples α[tₖ] from acceleration samples aₖ, occurring at times t₀, t₁, . . . , tₙ, for integration time interval tₛₜₐᵣₜ to t_{end}. The samples may, for example, be rotated to a computed coordinate system specified at an integration start time tₛₜₐᵣₜ. For this, an actual coordinate system orientation at tₛₜₐᵣₜ may not need to be known, for example, only relative rotations between this coordinate system and coordinate systems at an acceleration sampling times. Likewise, here, acceleration samples may be rotated using any suitable amount of rotation, such as utilizing, for example, quaternions, just to illustrate one possible implementation. As was indicated, in some instances, quaternions may represent rotations from a coordinate system at tₖ (e.g., back, etc.) to a coordinate system at tₛₜₐᵣₜ as, for example:

ā[tₖ]=qₜ_{_{start,}}ₜ_{ₖ}·\vec{a}ₖ·q*ₜ_{_{start,}}ₜ_{ₖ}

This relation may, for example, be considered to be equivalent to a following rotation utilizing a matrix:

$$[ \begin{matrix}{\{ a [ {t}_{k} ] \}}_{1} \\ {\{ a [ {t}_{k} ] \}}_{2} \\ {\{ a [ {t}_{k} ] \}}_{3}\end{matrix} ] = [ \begin{matrix}2 {q}_{0}^{2} + 2 {q}_{1}^{2} - 1 & 2 {q}_{1} {q}_{2} - 2 {q}_{0} {q}_{3} & 2 {q}_{1} {q}_{3} + 2 {q}_{0} {q}_{2} \\ 2 {q}_{1} {q}_{2} + 2 {q}_{0} {q}_{3} & 2 {q}_{0}^{2} + 2 {q}_{2}^{2} - 1 & 2 {q}_{2} {q}_{3} - 2 {q}_{0} {q}_{1} \\ 2 {q}_{1} {q}_{3} - 2 {q}_{0} {q}_{2} & 2 {q}_{2} {q}_{3} + 2 {q}_{0} {q}_{1} & 2 {q}_{0}^{2} + 2 {q}_{3}^{2} - 1\end{matrix} ] \cdot [ \begin{matrix}{\{ {a}_{k} \}}_{1} \\ {\{ {a}_{k} \}}_{2} \\ {\{ {a}_{k} \}}_{3}\end{matrix} ]$$

wherein the following notation may be utilized (e.g., for brevity, etc.):

$$[ \begin{matrix}{q}_{0} \\ {q}_{1} \\ {q}_{2} \\ {q}_{3}\end{matrix} ] = [ \begin{matrix}{\{ {q}_{{t}_{start} , {t}_{k}} \}}_{0} \\ {\{ {q}_{{t}_{start} , {t}_{k}} \}}_{1} \\ {\{ {q}_{{t}_{start} , {t}_{k}} \}}_{2} \\ {\{ {q}_{{t}_{start} , {t}_{k}} \}}_{3}\end{matrix} ]$$

An acceleration Rotation Module may provide or make available rotated acceleration samples to a suitable module, such as, for example, an Acceleration Integrator Module discussed below so as to produce or implement an integrated acceleration.

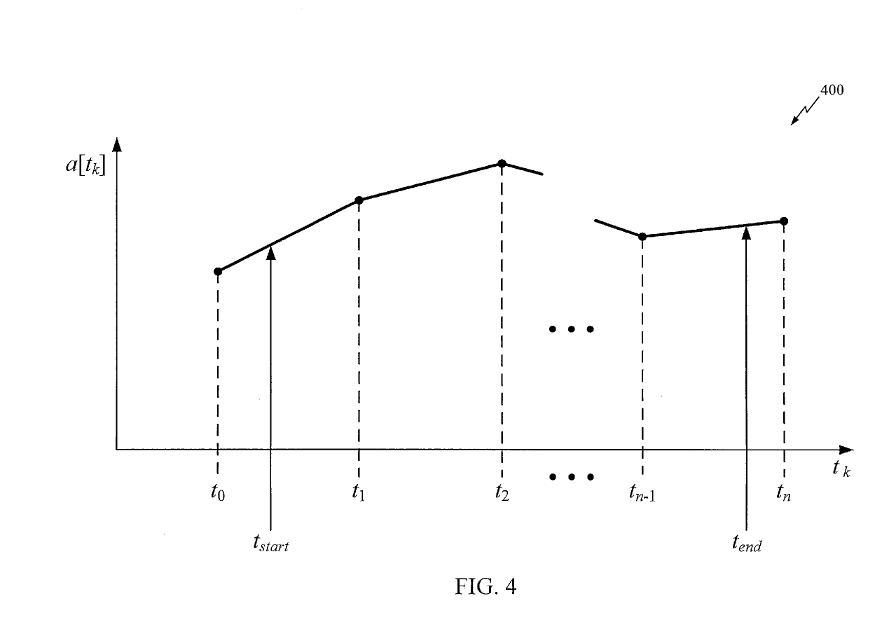

Thus, at operation 216, an Acceleration Integrator Module may, for example, ensure in some manner that accelerations are properly integrated over a requested time interval, since sensor time stamps and integration times are not synchronized (e.g., sensor samples may arrive at irregular times, etc.). For example, in some instances, an Acceleration Integrator Module may compute an integral of rotated acceleration samples āₜ_{ᵢ}_{^{a}} at times tᵢ^{a} for an integration time tₛₜₐᵣₜ to t_{end}. In at least one implementation, here, a trapezoidal-type integration may, for example, be utilized, in whole or in part, though claimed subject matter is not so limited. A trapezoidal-type integration is illustrated via an implementation of an example plot 400 of FIG. 4. As seen in this example, acceleration may be assumed to be linearly changing between samples. Such an integral may, for example, be represented as follows:

$${\int }_{{t}_{start}}^{{t}_{end}} a [ {t}_{k} ] d t = \frac{a [ {t}_{1} ] + a [ {t}_{start} ]}{2} \cdot ( {t}_{1} - {t}_{start} ) + {\sum }_{i = 2}^{n - 1} \frac{a [ {t}_{i} ] + a [ {t}_{i - 1} ]}{2} \cdot ( {t}_{i} - {t}_{i - 1} ) + \frac{a [ {t}_{end} ] + a [ {t}_{n - 1} ]}{2} \cdot ( {t}_{end} - {t}_{n - 1} )$$

$$where$$

$$a [ {t}_{start} ] = a [ {t}_{0} ] + ( a [ {t}_{1} ] - a [ {t}_{0} ] ) \cdot \frac{( {t}_{start} - {t}_{0} )}{( {t}_{1} - {t}_{0} )}$$

$$a [ {t}_{end} ] = a [ {t}_{n - 1} ] + ( a [ {t}_{n} ] - a [ {t}_{n - 1} ] ) \cdot \frac{( {t}_{end} - {t}_{n - 1} )}{( {t}_{n} - {t}_{n - 1} )}$$

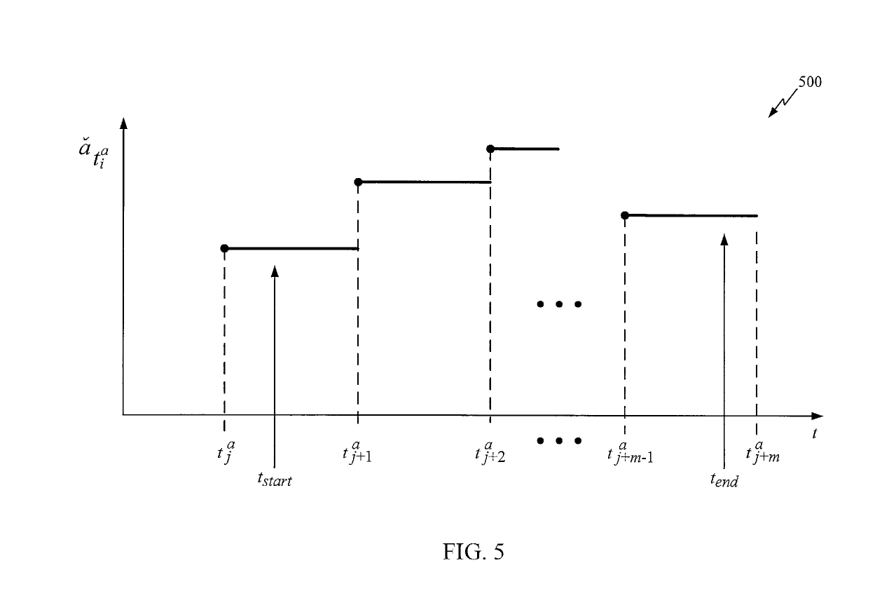

It should be understood, however, that this is merely an example implementation that employs a trapezoidal-type integration, and that other integration schemes or approaches may be used, in whole or in part. For example, as illustrated via an implementation of an example plot 500 of FIG. 5, in some instances, a rectangular-type integration with a forward constant may be employed. As illustrated, here, acceleration may be assumed to be constant between samples, for example, starting from a time stamp of an acceleration sample and lasting until a time stamp of the next sample. For this example, an integral may be expressed as follows:

$${\int }_{{t}_{start}}^{{t}_{end}} {\breve{a}}_{{t}_{i}^{a}} d t = {\breve{a}}_{{t}_{j}^{a}} \cdot ( {t}_{j + 1}^{a} - {t}_{start} ) + {\sum }_{i = j + 1}^{j + m - 2} {\breve{a}}_{{t}_{i}^{a}} \cdot ( {t}_{i + 1}^{a} - {t}_{i}^{a} ) + {\breve{a}}_{{t}_{j + m - 1}^{a}} \cdot ( {t}_{end} - {t}_{j + m - 1}^{a} )$$

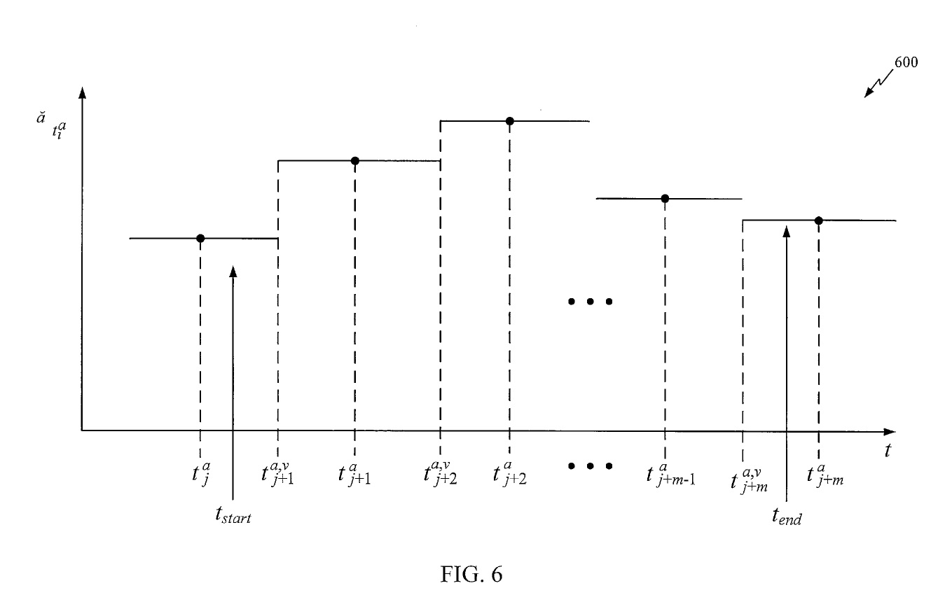

In another implementation, as illustrated via an example plot 600 of FIG. 6, an Acceleration Integrator Module may, for example, employ a rectangular-type integration using a central constant. Here, acceleration may be assumed to be constant around its sampling time, for example, spanning from the middle of a previous sampling interval to the next, surrounding a sample. This approach may, for example, be transformed into the previous one by defining virtual sampling times such that a sampling time tᵢ^{a} of a particular sample is shifted to the left until the middle of a sampling interval between the previous sample and a present one (e.g., tᵢ^{a,v}). For this example, an integral may be defined as:

$${\int }_{{t}_{start}}^{{t}_{end}} {\breve{a}}_{{t}_{i}^{a}} d t = {\breve{a}}_{{t}_{j}^{a}} \cdot ( {t}_{j + 1}^{a} - {t}_{start} ) + {\sum }_{i = j + 1}^{j + m - 2} {\breve{a}}_{{t}_{i}^{a}} \cdot ( {t}_{i + 1}^{a} - {t}_{i}^{a} ) + {\breve{a}}_{{t}_{j + m - 1}^{a}} \cdot ( {t}_{end} - {t}_{j + m - 1}^{a} )$$

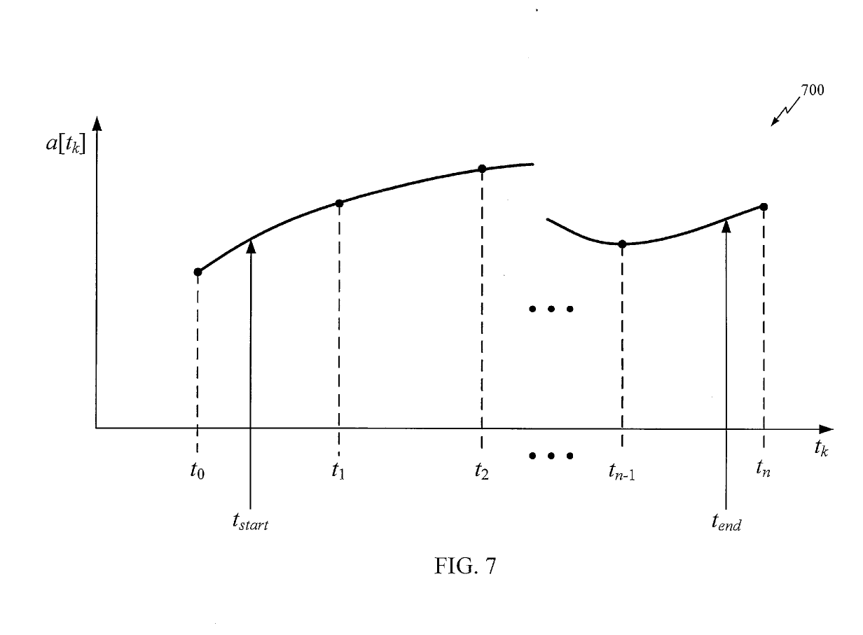

In yet another implementation, a spline-type integration may, for example, be employed. A spline-type integration is illustrated via an implementation of an example plot 700 of FIG. 7. As seen in this example, acceleration may, for example, be assumed to follow spline-type interpolation between samples. By way of example but not limitation, in certain simulations or experiments, it has been observed that, at times, a spline-type integration may prove beneficial in terms of accuracy, though claimed subject matter is not so limited to such an observation.

As was indicated, pre-processed inertial sensor measurements may, for example, be provided to a suitable navigation or positioning application or module, such as for further processing, for example, in connection with computing or utilizing delta velocity, average acceleration (e.g., delta velocity divided by time difference) over a time interval between tₛₜₑᵣₜ and t_{end}, or the like. A navigation or positioning application or module may, for example, estimate a motion state of a mobile device so as to facilitate or support one or more motion-enabled games, web page browsing, indoor or outdoor navigation, or the like.

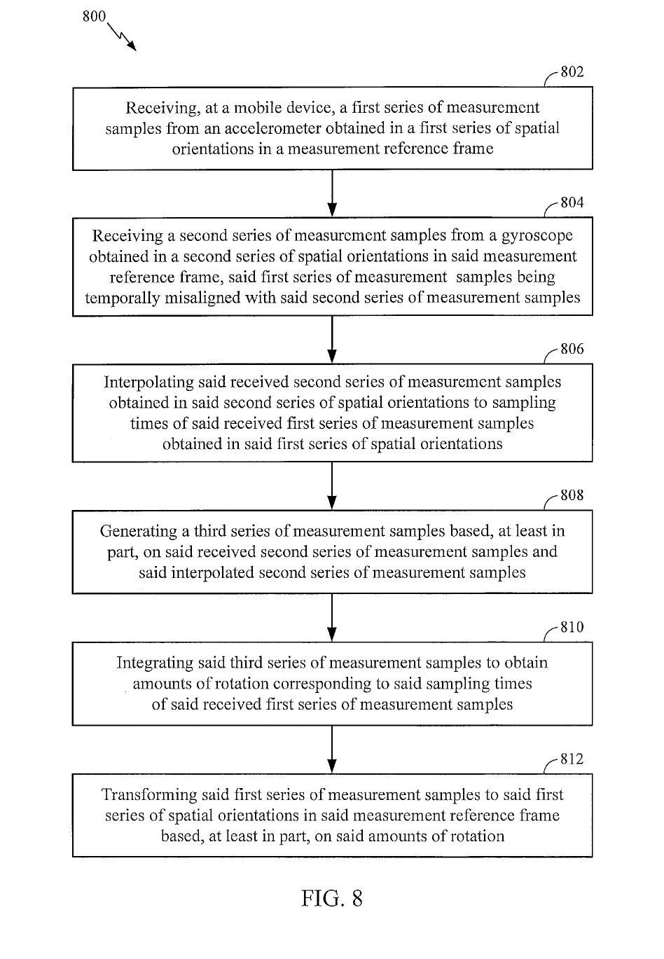

FIG. 8 is a flow diagram illustrating a summary of another implementation of an example process 800 that may be performed, in whole or in part, to facilitate or support one or more operations or techniques for pre-processing inertial sensor measurements for navigation for use in or with a mobile device, such as mobile device 102 of FIG. 1, for example. Again, here, information acquired or produced, such as, for example, input signals, output signals, operations, results, etc. associated with example process 800 may be represented via one or more digital signals. Likewise, even though one or more operations are illustrated or described concurrently or with respect to a certain sequence, other sequences or concurrent operations may be employed. Also, the description below may reference particular aspects or features illustrated in certain other figures, for example, and one or more operations may be performed with other aspects or features.

Example process 800 may, for example, begin at operation 802 with receiving, at a mobile device, a first series of measurement samples from an accelerometer obtained in a first series of spatial orientations in a measurement reference frame. At operation 804, a second series of measurement samples may be received, such as from a gyroscope, for example, obtained in a second series of spatial orientations in the measurement reference frame, the first series of measurement samples being temporally misaligned with the second series of measurement samples. At times, operations 802 and 804 may, for example, be performed or implemented concurrently, though claimed subject matter is not so limited. As was indicated, in some instances, acceleration samples (e.g., a first series of measurement samples, etc.) and gyroscope samples (e.g., a second series of measurement samples, etc.) may arrive in separate messages or packets, for example, with possibly non-matching time stamps, covering a possibly different time interval, with varying delays that may be different for each sensor type. A certain group of samples, such as those for which acceleration and gyroscope samples are available at approximately the same time, for example, may be identified or selected so as to be pre-processed together. Here, an exact time match may not be required or useful, but certain conditions may, for example, enable more effective or efficient integration of measurements from an accelerometer and gyroscope, such as discussed above. In addition, since a spatial orientation of a sensor frame associated with a mobile device may change, measurement samples may, for example, be defined according to different coordinate systems (e.g., spatial orientations, etc.), as was also indicated.

Thus, at operation 806, received second series of measurement samples obtained in the second series of spatial orientations may, for example, be interpolated to sampling times of the received first series of measurement samples obtained in the first series of spatial orientations. For example, initially, gyroscope rates may be interpolated to acceleration sampling times as well as to integration start and end times. Here, any suitable interpolation methods or approaches may be utilized, in whole or in part. As a way of illustration, in at least one implementation, a linear-type interpolation may be employed. Subsequently, appropriate amounts of rotation between coordinate systems at acceleration sampling times and an integration start time, such as represented via quaternions, for example, may be computed. For example, amounts of rotation may be computed successively, such as using a previous quaternion that was computed up to a previous acceleration sample. In some instances, such as if no rotation is observed, an identity quaternion may, for example, be used or otherwise considered.

With regard to operation 808, a third series of measurement samples may, for example, be generated based, at least in part, on the received second series of measurement samples and the interpolated second series of measurement samples. For example, in some instances, a third series of measurement samples may comprise the received second series of measurement samples merged or augmented with the interpolated second series of measurement samples, just to illustrate one possible implementation. At times, the received second series of measurement samples may, for example, be merged or augmented with the interpolated second series of measurement samples for the purpose of performing the same or similar pre-processing operations on each of the measurement samples in a single (e.g., third) series.

At operation 810, the third series of measurement samples may, for example, be integrated so as to obtain amounts of rotation corresponding to the sampling times of the received first series of measurement samples. For example, in some instances, an integral of rotated acceleration samples may be computed via one or more approaches discussed above. Depending on an implementation, here, a trapezoidal-type integration, a rectangular-type integration with a forward constant, a rectangular-type integration with a central constant, a spline-type integration, or any combination thereof may, for example, be utilized, in whole or in part. As a result, a series of rotation angles may, for example, be computed at respective time stamps of original acceleration samples. Thus, for each acceleration sample, an amount of rotation represented via a corresponding rotation angle value (e.g., computed from a third series, etc.) may, for example, be obtained. As was indicated, in some instances, quaternions may, for example, be utilized, at least in part.

With regard to operation 812, the first series of measurement samples may, for example, be transformed to the first series of spatial orientations in the measurement reference frame based, at least in part, on the amounts of rotation. For example, as discussed above, using amounts of rotation represented via corresponding rotation angle values, acceleration samples may be rotated to a coordinate system at the beginning of an integration period, such as to map or align these samples in the same computed coordinate system. Transformed first series of measurement samples may, for example, be subsequently integrated so as to produce or implement an integrated acceleration that may be used, at least in part, to estimate a motion state of a mobile device. For example, an integrated acceleration may be used, at least in part, to determine or utilize a delta velocity, average acceleration, etc., or any combination thereof. At times, a motion state of a mobile device may, for example, be estimated so as to facilitate or support one or more motion-enabled games, web page browsing, indoor or outdoor navigation, or the like, as was also indicated.

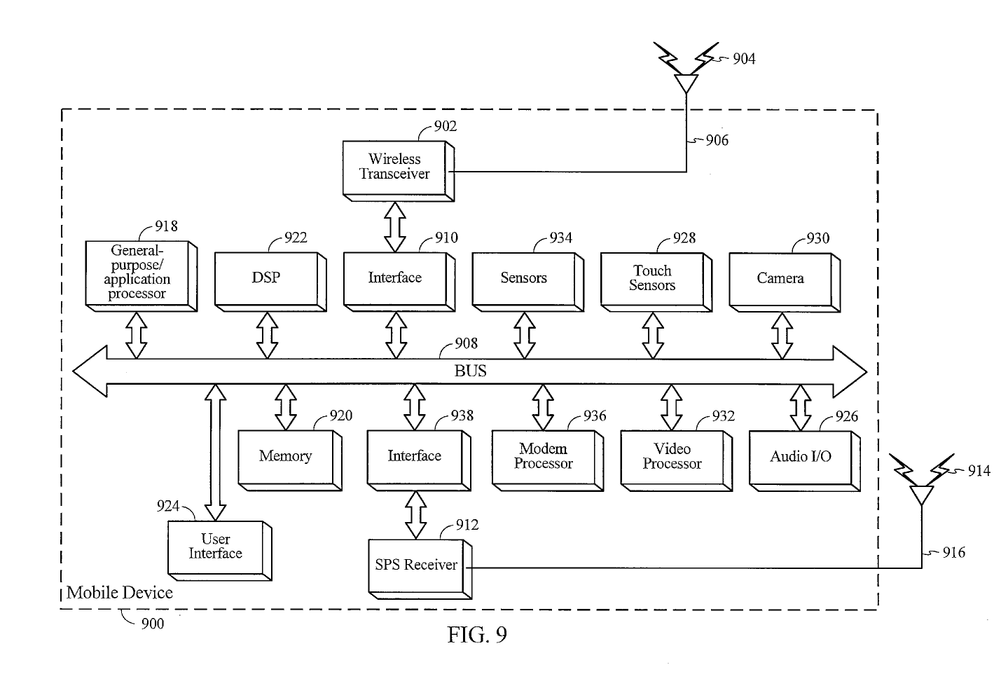

FIG. 9 is a schematic diagram of an implementation of an example computing environment associated with a mobile device that may be used, at least in part, to facilitate or support one or more operations or techniques for pre-processing inertial sensor measurements for navigation. An example computing environment may comprise, for example, a mobile device 900 that may include one or more features or aspects of mobile device 102 of FIG. 1, though claimed subject matter is not so limited. For example, in some instances, mobile device 900 may comprise a wireless transceiver 902 capable of transmitting or receiving wireless signals, referenced generally at 904, such as via an antenna 906 over a suitable wireless communications network. Wireless transceiver 902 may, for example, be coupled or connected to a bus 908 via a wireless transceiver bus interface 910. Depending on an implementation, at times, wireless transceiver bus interface 910 may, for example, be at least partially integrated with wireless transceiver 902. Some implementations may include multiple wireless transceivers 902 or antennas 906 so as to enable transmitting or receiving signals according to a corresponding multiple wireless communication standards such as Wireless Fidelity (WiFi), Code Division Multiple Access (CDMA), Wideband-CDMA (W-CDMA), Long Term Evolution (LTE), Bluetooth®, just to name a few examples.

In an implementation, mobile device 900 may, for example, comprise an SPS or like receiver 912 capable of receiving or acquiring one or more SPS or other suitable wireless signals 914, such as via an SPS or like antenna 916. SPS receiver 912 may process, in whole or in part, one or more acquired SPS signals 914 for estimating a location of mobile device 900. In some instances, one or more general-purpose application processors 918, memory 920, digital signal processor(s) (DSP) 922, or like specialized devices or processors not shown may be utilized to process acquired SPS signals 914, in whole or in part, calculate a location of mobile device 900, such as in conjunction with SPS receiver 912, or the like. Storage of SPS or other signals for implementing one or more positioning operations may be performed, at least in part, in memory 920, suitable registers or buffers (not shown). Although not shown, it should be appreciated that in at least one implementation one or more processors 918, memory 920, DSPs 922, or like specialized devices or processors may comprise one or more processing modules capable of receiving a first series of measurement samples from an accelerometer obtained in a first series of spatial orientations in a measurement reference frame; receiving a second series of measurement samples from a gyroscope obtained in a second series of spatial orientations in the measurement reference frame, the first series of measurement samples being temporally misaligned with the second series of measurement samples; interpolating the received second series of measurement samples obtained in the second series of spatial orientations to sampling times of the received first series of measurement samples obtained in the first series of spatial orientations; generating a third series of measurement samples based, at least in part, on the received second series of measurement samples and the interpolated second series of measurement samples; integrating the third series of measurement samples to obtain amounts of rotation corresponding to the sampling times of the received first series of measurement samples; and transforming the first series of measurement samples to the first series of spatial orientations in the measurement reference frame based, at least in part, on the amounts of rotation. It should also be noted that all or part of one or more processing modules may be implemented using or otherwise including hardware, firmware, software, or any combination thereof.

In some instances, one or more processors 918, memory 920, DSPs 922, or like specialized devices or processors may comprise, for example, or be representative of means for receiving a first and second series of measurement samples, such as discussed above with respect to operations 802 and 804 of FIG. 8 as well as various example implementations. As previously mentioned, means for receiving a first and second series of measurement samples may, for example, facilitate or support means for interpolating received second series of measurement samples, as illustrated in or described with respect to operation 806 of FIG. 8. At times, one or more processors 918, memory 920, DSPs 922, or like specialized devices or processors may comprise, for example, or be representative of means for generating a third series of measurement samples based, at least in part, on the received second series of measurement samples and the interpolated second series of measurement samples, as also discussed above. In addition, in at least one implementation, one or more processors 918, memory 920, DSPs 922, or like specialized devices or processors may comprise, for example, or be representative of means for integrating the third series of measurement samples to obtain amounts of rotation corresponding to the sampling times of the received first series of measurement samples, such as discussed in connection with operation 810 of FIG. 8. Also, depending on an implementation, one or more processors 918, memory 920, DSPs 922, or like specialized devices or processors may comprise, for example, or be representative of means for transforming the first series of measurement samples to the first series of spatial orientations in the measurement reference frame based, at least in part, on the amounts of rotation (e.g., via operation 812 of FIG. 8, etc.).

As illustrated, DSP 922 may be coupled or connected to processor 918 and memory 920 via bus 908. Although not shown, in some instances, bus 908 may comprise one or more bus interfaces that may be integrated with one or more applicable components of mobile device 900, such as DSP 922, processor 918, memory 920, or the like. In various embodiments, one or more operations or functions described herein may be performed in response to execution of one or more machine-readable instructions stored in memory 920, such as on a computer-readable storage medium, such as RAM, ROM, FLASH, disc drive, etc., just to name a few examples. Instructions may, for example, be executable via processor 918, one or more specialized processors not shown, DSP 922, or the like. Memory 920 may comprise a non-transitory processor-readable memory, computer-readable memory, etc. that may store software code (e.g., programming code, instructions, etc.) that may be executable by processor 918, DSP 922, or the like to perform operations or functions described herein.

Mobile device 900 may comprise a user interface 924, which may include any one of several devices such as, for example, a speaker, microphone, display device, vibration device, keyboard, touch screen, etc., just to name a few examples. In at least one implementation, user interface 924 may enable a user to interact with one or more applications hosted on mobile device 900. For example, one or more devices of user interface 924 may store analog or digital signals on memory 920 to be further processed by DSP 922, processor 918, etc. in response to input or action from a user. Similarly, one or more applications hosted on mobile device 900 may store analog or digital signals in memory 920 to present an output signal to a user. In some implementations, mobile device 900 may optionally include a dedicated audio input/output (I/O) device 926 comprising, for example, a dedicated speaker, microphone, digital to analog circuitry, analog to digital circuitry, amplifiers, gain control, or the like. It should be understood, however, that this is merely an example of how audio I/O device 926 may be implemented, and that claimed subject matter is not limited in this respect. As seen, mobile device 900 may comprise one or more touch sensors 928 responsive to touching or like pressure applied on a keyboard, touch screen, or the like.

In an implementation, mobile device 900 may comprise, for example, a camera 930, dedicated or otherwise, such as for capturing still or moving imagery, or the like. Camera 930 may comprise, for example, a camera sensor or like imaging device (e.g., charge coupled device, complementary metal oxide semiconductor (CMOS)-type imager, etc.), lens, analog to digital circuitry, frame buffers, etc., just to name a few examples. In some instances, additional processing, conditioning, encoding, or compression of signals representing one or more captured images may, for example, be performed, at least in part, at processor 918, DSP 922, or the like. Optionally or alternatively, a video processor 932, dedicated or otherwise, may perform conditioning, encoding, compression, or manipulation of signals representing one or more captured images. Additionally, video processor 932 may, for example, decode or decompress one or more stored images for presentation on a display (not shown) of mobile device 900.

Mobile device 900 may comprise one or more sensors 934 coupled or connected to bus 908, such as, for example, one or more inertial sensors, ambient environment sensors, or the like. Inertial sensors of sensors 934 may comprise, for example, one or more accelerometers (e.g., collectively responding to acceleration of mobile device 900 in one, two, or three dimensions, etc.), gyroscopes, magnetometers (e.g., to support one or more compass or like applications, etc.), etc., just to illustrate a few examples. Ambient environment sensors of mobile device 900 may comprise, for example, one or more temperature sensors, barometric pressure sensors, ambient light detectors, camera sensors, microphones, etc., just to name few examples. Sensors 934 may generate analog or digital signals that may be stored in memory 920 and may be processed by DSP 922, processor 918, etc., such as in support of one or more applications directed to positioning or navigation operations, communications, gaming or the like.

In a particular implementation, mobile device 900 may comprise a modem processor 936, dedicated or otherwise, capable of performing baseband processing of signals received or downconverted via wireless transceiver 902, SPS receiver 912, or the like. Similarly, modem processor 936 may perform baseband processing of signals to be upconverted for transmission via wireless transceiver 902, for example. In alternative implementations, instead of having a dedicated modem processor, baseband processing may be performed, at least in part, by processor 918, DSP 922, or the like. In addition, in some instances, an interface 938, although illustrated as a separate component, may be integrated, in whole or in part, with one or more applicable components of mobile device 900, such as bus 908 or SPS receiver 912, for example. Optionally or alternatively, SPS receiver 912 may be coupled or connected to bus 908 directly. It should be understood, however, that these are merely examples of components or structures that may perform baseband processing, and that claimed subject matter is not limited in this regard.

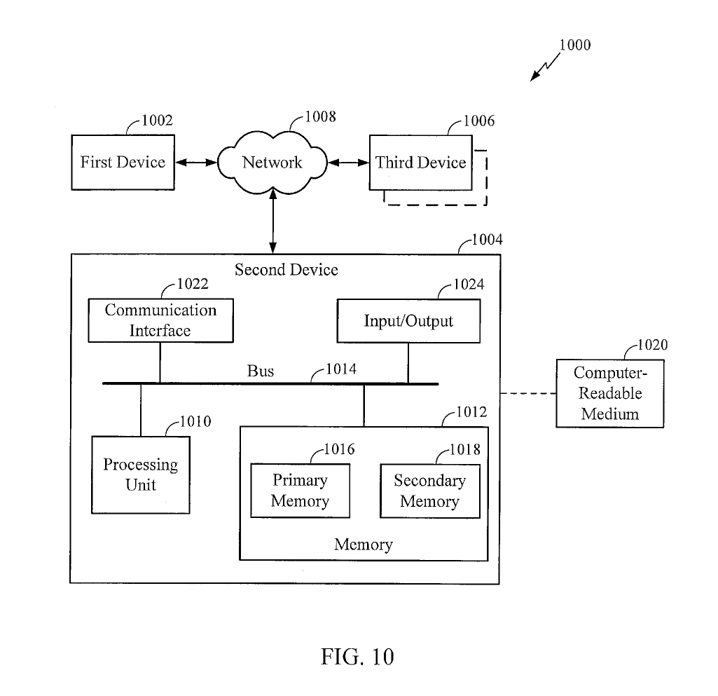

FIG. 10 is a schematic diagram illustrating an implementation of an example computing environment or system 1000 that may be associated with or include one or more servers or other devices capable of partially or substantially implementing or supporting one or more operations or techniques for pre-processing inertial sensor measurements for navigation, such as discussed above in connection with FIGS. 1-8, for example. Computing environment 1000 may include, for example, a first device 1002, a second device 1004, a third device 1006, etc., which may be operatively coupled together via a communications network 1008. In some instances, first device 1002 may comprise a server capable of providing positioning assistance data, such as, for example, identities or locations of known wireless transmitters, radio heat map, probe request or response, base station almanac, digital map, location context identifier (LCI), or the like. In some instances, first device 1002 may comprise a server capable of providing suitable measurement samples, such as, for example, acceleration samples, gyroscope samples, or like. First device 1002 may also comprise a server capable of providing an LCI to a requesting mobile device based, at least in part, on a rough estimate of a location of the mobile device. First device 1002 may also comprise a server capable of providing indoor positioning assistance data relevant to a location of an LCI specified in a request from a mobile device. Second device 1004 or third device 1006 may comprise, for example, mobile devices, just to illustrate one possible implementation. In addition, communications network 1008 may comprise one or more wireless transmitters, such as access points, femtocells, or the like. Of course, claimed subject matter is not limited in scope in these respects.

First device 1002, second device 1004, or third device 1006 may be representative of any device, appliance, platform, or machine that may be capable of exchanging information over communications network 1008. By way of example but not limitation, any of first device 1002, second device 1004, or third device 1006 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 1002, 1004, and 1006, respectively, may comprise one or more of a mobile device, wireless transmitter or receiver, server, etc. in accordance with example implementations described herein.

In an implementation, communications network 1008 may be representative of one or more communication links, processes, or resources capable of supporting an exchange of information between at least two of first device 1002, second device 1004, or third device 1006. By way of example but not limitation, communications network 1008 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 1006, there may be additional like devices operatively coupled to communications network 1008. It is also recognized that all or part of various devices or networks shown in computing environment 1000, or processes or methods, as described herein, may be implemented using or otherwise including hardware, firmware, software, or any combination thereof.

By way of example but not limitation, second device 1004 may include at least one processing unit 1010 that may be operatively coupled to a memory 1012 via a bus 1014. Processing unit 1010 may be representative of one or more circuits capable of performing at least a portion of a suitable computing procedure or process. For example, processing unit 1010 may include one or more processors, controllers, microprocessors, microcontrollers, application specific integrated circuits, digital signal processors, programmable logic devices, field programmable gate arrays, or the like, or any combination thereof.

In certain server-based or server-supported implementations, processing unit 1010 may comprise, for example, or be representative of means for receiving or communicating a first series of measurement samples from an accelerometer obtained in a first series of spatial orientations in a measurement reference frame, as well as means for receiving or communicating a second series of measurement samples from a gyroscope obtained in a second series of spatial orientations in the measurement reference frame, as illustrated in or described with respect to operations 802 and 804 of FIG. 8. As was indicated, at times, the first series of measurement samples may, for example, be temporally misaligned with the second series of measurement samples. In at least one implementation, processing unit 1010 may comprise, for example, or be representative of means for interpolating the received second series of measurement samples obtained in the second series of spatial orientations to sampling times of the received first series of measurement samples obtained in the first series of spatial orientations, as discussed above. In some instances, processing unit 1010 may comprise, for example, or be representative of means for generating a third series of measurement samples based, at least in part, on the received second series of measurement samples and the interpolated second series of measurement samples. Also, at times, processing unit 1010 may comprise or be representative of means for integrating the third series of measurement samples, for example, as well as means for transforming the first series of measurement samples to the first series of spatial orientations in the measurement reference frame, such as via operations 810 and 812 of FIG. 8.

Memory 1012 may be representative of any information storage mechanism or appliance. Memory 1012 may include, for example, a primary memory 1016 and a secondary memory 1018. Primary memory 1016 may include, for example, a random access memory, read only memory, etc. While illustrated in this example as being separate from processing unit 1010, it should be understood that all or part of primary memory 1016 may be provided within or otherwise co-located/coupled with processing unit 1010. Secondary memory 1018 may include, for example, same or similar type of memory as primary memory or one or more information storage devices or systems, such as, for example, a disk drive, an optical disc drive, a tape drive, a solid state memory drive, etc. In certain implementations, secondary memory 1018 may be operatively receptive of, or otherwise configurable to couple to, a computer-readable medium 1020. Computer-readable medium 1020 may include, for example, any non-transitory storage medium that may carry or make accessible information, code, or instructions for one or more of devices in computing environment 1000. Computer-readable medium 1020 may also be referred to as a storage medium.

Second device 1004 may include, for example, a communication interface 1022 that may provide for or otherwise support an operative coupling of second device 1004 to at least communications network 1008. By way of example but not limitation, communication interface 1022 may include a network interface device or card, a modem, a router, a switch, a transceiver, and the like. Second device 1004 may also include, for example, an input/output device 1024. Input/output device 1024 may be representative of one or more devices or features that may be configurable to accept or otherwise introduce human or machine inputs, or one or more devices or features that may be capable of delivering or otherwise providing for human or machine outputs. By way of example but not limitation, input/output device 1024 may include an operatively configured display, speaker, keyboard, mouse, trackball, touch screen, information port, or the like.

Methodologies described herein may be implemented by various means depending upon applications according to particular features or examples. For example, methodologies may be implemented in hardware, firmware, software, discrete/fixed logic circuitry, any combination thereof, and so forth. In a hardware or logic circuitry implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, methodologies may be implemented with modules (e.g., procedures, functions, etc.) having instructions that perform functions described herein. Any computer-readable medium tangibly embodying instructions may be used in implementing methodologies described herein. For example, software codes may be stored in a memory and executed by a processor. Memory may be implemented within the processor or external to the processor. As used herein the term “memory” may refer to any type of long term, short term, volatile, non-volatile, or other memory and is not to be limited to any particular type of memory or number of memories, or type of media upon which memory is stored. In at least some implementations, one or more portions of the herein described storage media may store signals representative of information as expressed by a particular state of the storage media. For example, an electronic signal representative of information may be “stored” in a portion of the storage media (e.g., memory) by affecting or changing the state of such portions of the storage media to represent information as binary information (e.g., via ones and zeros). As such, in a particular implementation, such a change of state of the portion of the storage media to store a signal representative of information constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to store desired program code in the form of instructions or information structures and that may be accessed by a computer or processor thereof. Disk and disc, as used herein, includes compact disc (CD), laser disc, optical disc, digital versatile disc (DVD), floppy disk and blue-ray disc where disks usually reproduce information magnetically, while discs reproduce information optically with lasers.

As discussed above, a mobile device may be capable of communicating with one or more other devices via wireless transmission or receipt of information over various communications networks using one or more wireless communication techniques. Here, for example, wireless communication techniques may be implemented using a wireless wide area network (WWAN), a wireless local area network (WLAN),a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rdGeneration Partnership Project” (3GPP). Cdma2000 is described in documents from a consortium named “3rd Generation Partnership Project 2”(3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

In an implementation, a mobile device may, for example, be capable of communicating with one or more femtocells, such as for the purpose of estimating its location, obtaining positioning assistance data or measurement samples, extending cellular telephone service into a business or home, or the like. As used herein, “femtocell” may refer to one or more smaller-size cellular base stations that may be capable of detecting a wireless signal transmitted from a mobile device using one or more appropriate techniques. Typically, although not necessarily, a femtocell may utilize or otherwise be compatible with various types of communication technology such as, for example, Universal Mobile Telecommunications System (UTMS), Long Term Evolution (LTE), Evolution-Data Optimized or Evolution-Data only (EV-DO), GSM, Worldwide Interoperability for Microwave Access (WiMAX), Code division multiple access (CDMA)-2000, or Time Division Synchronous Code Division Multiple Access (TD-SCDMA), to name just a few examples among many possible. In certain implementations, a femtocell may comprise integrated WiFi, for example, and may provide a mobile device access to a larger cellular telecommunication network by way of another broadband network, such as the Internet. However, such details relating to femtocells are merely examples, and claimed subject matter is not so limited.

Techniques described herein may be used with an SPS that includes any one of several GNSS or combinations of GNSS. Furthermore, techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal, etc.). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “space vehicle” (SV), as used herein, is intended to include terrestrial transmitters acting as pseudolites, equivalents of pseudolites, and possibly others. The terms “SPS signals” or “SV signals”, as used herein, is intended to include SPS-like signals from terrestrial transmitters, including terrestrial transmitters acting as pseudolites or equivalents of pseudolites.

Also, computer-readable code or instructions may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media. Such computer instructions may be transmitted in portions (e.g., first and second portions) at different times (e.g., at first and second times). Some portions of this Detailed Description are presented in terms of algorithms or symbolic representations of operations on binary digital signals stored within a memory of a specific apparatus or special purpose computing device or platform. In the context of this particular Specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated.

It has proven convenient at times, principally for reasons of common usage, to refer to signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
receiving, at a mobile device, a first series of measurement samples from an accelerometer obtained in a first series of spatial orientations in a measurement reference frame;
receiving a second series of measurement samples from a gyroscope obtained in a second series of spatial orientations in said measurement reference frame, said first series of measurement samples being temporally misaligned with said second series of measurement samples;
interpolating said received second series of measurement samples obtained in said second series of spatial orientations to sampling times of said received first series of measurement samples obtained in said first series of spatial orientations;
generating a third series of measurement samples based, at least in part, on said received second series of measurement samples and said interpolated second series of measurement samples;
integrating said third series of measurement samples to obtain amounts of rotation corresponding to said sampling times of said received first series of measurement samples; and
transforming said first series of measurement samples to said first series of spatial orientations in said measurement reference frame based, at least in part, on said amounts of rotation.

2. The method of claim 1, and further comprising:
integrating said transformed first series of measurement samples to produce an integrated acceleration used, at least in part, to estimate a motion state of said mobile device.

3. The method of claim 2, wherein said integrated acceleration is used, at least in part, to determine at least one of the following: a delta velocity; average acceleration; or any combination thereof.

4. The method of claim 1, wherein at least one of said amounts of rotation comprises a quaternion representative of a rotation between two samples of said first series of measurement samples.

5. The method of claim 4, wherein said rotation between said two samples comprises an average rotation rate vector between two respective boundary time stamps of said two samples.

6. The method of claim 4, wherein said quaternion is computed successively utilizing, at least in part, at least one previous quaternion computed up to a previous sample of said first series of measurement samples.

7. The method of claim 4, wherein said quaternion is representative of a rotation between measurement reference frames of said first series of spatial orientations and said second series of spatial orientations at sampling times of said first series of measurement samples.

8. The method of claim 7, wherein said sampling times comprise irregular sampling times.

9. The method of claim 1, wherein said integrating is performed via at least one of the following: a trapezoidal-type integration; a rectangular-type integration with a forward constant; a rectangular-type integration with a central constant; a spline-type integration; or any combination thereof.

10. The method of claim 1, wherein said third series of measurement samples comprise said received second series of measurement samples merged with said interpolated second series of measurement samples.

11. The method of claim 1, wherein said sampling times of said received first series of measurement samples are represented via respective time stamps.

12. The method of claim 1, and further comprising:
interpolating said received second series of measurement samples obtained in said second series of spatial orientations to integration start and end times.

13. The method of claim 1, wherein said interpolating is performed via a liner-type interpolation operation.

14. The method of claim 1, and further comprising:
resetting an accumulation period of said third series of measurement samples based, at least in part, on at least one of the following: a new position fix obtained in conjunction with one or more applicable sensor biases; a threshold of said accumulation period of said third series of measurement samples; or any combination thereof.

15. The method of claim 1, wherein said first series of measurement samples and said second series of measurement samples are time-stamped.

16. The method of claim 1, wherein said first series of measurement samples and said second series of measurement samples are not synchronized.

17. An apparatus comprising:
a mobile device comprising:
an accelerometer;
a gyroscope; and
one or more processors programmed with instructions to:
receive a first series of measurement samples from said accelerometer obtained in a first series of spatial orientations in a measurement reference frame;
receive a second series of measurement samples from said gyroscope obtained in a second series of spatial orientations in said measurement reference frame, said first series of measurement samples being temporally misaligned with said second series of measurement samples;
interpolate said received second series of measurement samples obtained in said second series of spatial orientations to sampling times of said received first series of measurement samples obtained in said first series of spatial orientations;
generate a third series of measurement samples based, at least in part, on said received second series of measurement samples and said interpolated second series of measurement samples;
integrate said third series of measurement samples to obtain amounts of rotation corresponding to said sampling times of said received first series of measurement samples; and
transform said first series of measurement samples to said first series of spatial orientations in said measurement reference frame based, at least in part, on said amounts of rotation.

18. The apparatus of claim 17, wherein said one or more processors further programmed with instructions to:
integrate said transformed first series of measurement samples to produce an integrated acceleration used, at least in part, to estimate a motion state of said mobile device.

19. The apparatus of claim 17, wherein said one or more processors further programmed with instructions to:
reset an accumulation period of said third series of measurement samples based, at least in part, on at least one of the following: a new position fix obtained in conjunction with one or more applicable sensor biases; a threshold of said accumulation period of said third series of measurement samples; or any combination thereof.

20. An article comprising:
a non-transitory storage medium having instructions stored thereon executable by a special purpose computing platform to:
receive, at a mobile device, a first series of measurement samples from an accelerometer obtained in a first series of spatial orientations in a measurement reference frame;
receive a second series of measurement samples from a gyroscope obtained in a second series of spatial orientations in said measurement reference frame, said first series of measurement samples being temporally misaligned with said second series of measurement samples;
interpolate said received second series of measurement samples obtained in said second series of spatial orientations to sampling times of said received first series of measurement samples obtained in said first series of spatial orientations;
generate a third series of measurement samples based, at least in part, on said received second series of measurement samples and said interpolated second series of measurement samples;
integrate said third series of measurement samples to obtain amounts of rotation corresponding to said sampling times of said received first series of measurement samples; and
transform said first series of measurement samples to said first series of spatial orientations in said measurement reference frame based, at least in part, on said amounts of rotation.
